(19) United States
(12) Patent Application Publication
(10) Pub. No.: US 2023/0176282 A1
(43) Pub. Date: Jun. 8, 2023

(54) Photonic Bandpass Filters with Polarization Diversity

(71) Applicant: Raytheon BBN Technologies Corp., Cambridge, MA (US)

(72) Inventors: Moe D. Soltani, Belmont, MA (US); Anshuman Singh, Cambridge, MA (US)

(21) Appl. No.: 18/074,366

(22) Filed: Dec. 2, 2022

Related U.S. Application Data
(60) Provisional application No. 63/285,751, filed on Dec. 3, 2021.

(51) Int. Cl. G02B 6/12; G02B 6/126

(52) U.S. Cl. CPC G02B 6/12004; G02B 6/126; G02B 2006/12109; G02B 2006/12147

(57) ABSTRACT

A photonic integrated circuit (“PIC”) bandpass filter with polarization diversity can comprise a polarization management stage operable to receive a polarization diverse light input and to output an intermediate beam having a uniform polarization, and a filter stage operable to receive the intermediate beam from the polarization management stage, to filter the intermediate beam, and to output a filter output beam. Energy from both an in-plane polarization and an out-of-plane polarization of the polarization diverse light input can thereby be transferred to the filter stage.

### CROSS REFERENCE TO RELATED APPLICATION

This application claims the benefit of U.S. Provisional Application No. 63/285,751 which was filed on Dec. 3, 2021, which is incorporated by reference herein in its entirety.

### BACKGROUND

Typical photonic integrated circuit (“PIC”) bandpass filters (or photonic bandpass filters) are sensitive to the input signal polarization due to their strong refractive index contrast. Thus, typical PIC bandpass filters generally require a linearly polarized input to achieve optimum performance. In practice, optical fiber networks often carry a random polarization of light. Though there have been many advances in PIC bandpass filters, most efforts have demonstrated filters for a specific linear polarization. Therefore, there is still a need for PIC bandpass filters (such as silicon PIC bandpass filters or other PIC bandpass filters) that can achieve high performance with a light input that has a random polarization.

### BRIEF DESCRIPTION OF THE DRAWINGS

Features and advantages of the subject technology will be apparent from the detailed description which follows, taken in conjunction with the accompanying drawings, which together illustrate, by way of example, features of the subject technology; and, wherein:

FIG. 1 shows a schematic view of a PIC bandpass filter with polarization diversity according to one example of the present disclosure.

FIG. 2 shows a schematic view of PIC bandpass filter with polarization diversity according to one example of the present disclosure.

FIG. 3 shows a schematic view of a PIC bandpass filter with polarization diversity according to one example of the present disclosure.

FIGS. 4A and 4B show examples of measured spectral responses of a filter structure comparing a PIC bandpass filter with polarization diversity such as shown in FIGS. 1-3 to a PIC bandpass filter without polarization diversity.

FIG. 5 shows a method of filtering polarization diverse light input on a photonic integrated circuit (“PIC”) bandpass filter according to one example of the present disclosure.

FIG. 6 shows a method of filtering polarization diverse light input on a photonic integrated circuit (“PIC”) bandpass filter according to one example of the present disclosure.

Reference will now be made to the examples illustrated, and specific language will be used herein to describe the same. It will nevertheless be understood that no limitation of scope is thereby intended.

### DETAILED DESCRIPTION

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter.

Given the above, there is a need for implementing PIC bandpass filters that are polarization insensitive (i.e. that are compatible with polarization diverse light input). Such PIC bandpass filters can be beneficial for a wide range of signal processing applications in classical and quantum photonics. According to one example of the present disclosure, a photonic integrated circuit (“PIC”) bandpass filter with polarization diversity can comprise a polarization management stage operable to receive a polarization diverse light input and to output an intermediate beam having a uniform polarization, and a filter stage operable to receive the intermediate beam from the polarization management stage, to filter the intermediate beam, and to output a filter output beam. Energy from both an in-plane polarization and an out-of-plane polarization of the polarization diverse light input can thereby be transferred to the filter stage.

In some examples the polarization management stage can comprise a light splitter. The light splitter can be operable to split the polarization diverse light input into a first beam having a first polarization and a second beam having a second polarization different than the first polarization. The polarization management stage can further comprise a polarization rotator. The polarization rotator can be operable to rotate the first polarization of the first beam such that the first beam comprises a rotated polarization that matches the second polarization.

In some examples, the polarization management stage can comprise a beam coupler. The beam coupler can couple or combine the first beam having the rotated polarization and the second beam having the second polarization into an intermediate beam. The polarization management stage can also comprise a phase shifter operable to shift a phase of the second beam to match a phase of the first beam prior to the first and second beams being received by the beam coupler.

In some examples, the intermediate beam can comprise a first intermediate beam and a second intermediate beam. The filter stage can comprise a first filter that receives the first intermediate beam and a second filter that receives the second intermediate beam. The first filter can output a first filtered intermediate output and the second filter can output a second filtered intermediate output.

In some examples, the filter stage can further comprise a power combiner operable to receive and combine the first filtered intermediate output and the second filtered intermediate output to output the filter output beam. The filter stage can also comprise a bias tee operable to receive the first filtered intermediate output and the second filtered intermediate output and to output a first biased intermediate output and a second biased intermediate output to the power combiner.

In another example of the present disclosure, a photonic integrated circuit (“PIC”) bandpass filter with polarization diversity can comprise a polarization management stage. The polarization management stage can comprise a light splitter. The light splitter can be operable to split a polarization diverse light input into a first beam having a first polarization and a second beam having a second polarization different than the first polarization.

The polarization management phase can also comprise a polarization rotator operable to rotate the first polarization of the first beam such that the first beam comprises a rotated polarization that matches the second polarization. The PIC can also comprise a filter stage operable to receive and filter the first beam and the second beam received from the polarization management stage and to output a filter output beam. In this manner, energy from both an in-plane polarization and an out-of-plane polarization of the polarization diverse light input can be transferred to the filter stage.

In some examples, the polarization management stage can comprise a beam coupler coupling the first beam having the rotated polarization and the second beam having the second polarization into an intermediate beam. The filter stage can be operable to receive and filter the intermediate beam to output the filter output beam.

In some examples, the polarization management stage can comprise a phase shifter. The phase shifter can be operable to shift a phase of the second beam to match a phase of the first beam prior to the first and second beams being received by the beam coupler.

In some examples, the filter stage can comprise a first filter that receives the first beam and a second filter that receives the second beam. The first filter can output a first filtered intermediate output and the second filter can output a second filtered intermediate output. The filter stage can further comprise a power combiner operable to receive and combine the first filtered intermediate output and the second filtered intermediate output to output the filter output beam. The filter stage can comprise a bias tee operable to receive the first filtered intermediate output and the second filtered intermediate output and to output a first biased intermediate output and a second biased intermediate output to the power combiner.

In another example of the present disclosure, a method for filtering polarization diverse light input on a photonic integrated circuit (“PIC”) bandpass filter is provided. The method can comprise splitting a polarization diverse light input into a first beam having a first polarization and a second beam having a second polarization than the first polarization, rotating the first polarization of the first beam such that the first beam comprises a rotated polarization that matches the second polarization, filtering the first beam comprising the rotated polarization and the second beam comprising the second polarization, and outputting a filter output beam.

In some examples, the method can also comprise comprising combining the first beam and the second beam into an intermediate beam prior to the filtering. In some examples, the method can comprise phase shifting the second beam prior to the combining such that a phase of the second beam matches a phase of the first beam.

In some examples, the first beam can be filtered by a first filter to output a first filtered intermediate output, the second team can be filtered by a second filter to output a second filtered intermediate output, and the first filtered intermediate output can be combined with the second filtered intermediate output to output the filter output beam.

In another example of the present disclosure, a polarization management device for a photonic bandpass filter is provided. The polarization management device can comprise a light splitter. The light splitter can be operable to split a polarization diverse light input into a first beam having a first polarization and a second beam having a second polarization different than the first polarization. The polarization management device can also comprise a polarization rotator. The polarization rotator can be operable to rotate the first polarization of the first beam such that the first beam comprises a rotated polarization that matches the second polarization. The polarization management device can further comprise a beam coupler. The beam coupler can be operable to couple or combine the first beam and the second beam into an intermediate beam that can be output to polarization sensitive filter input.

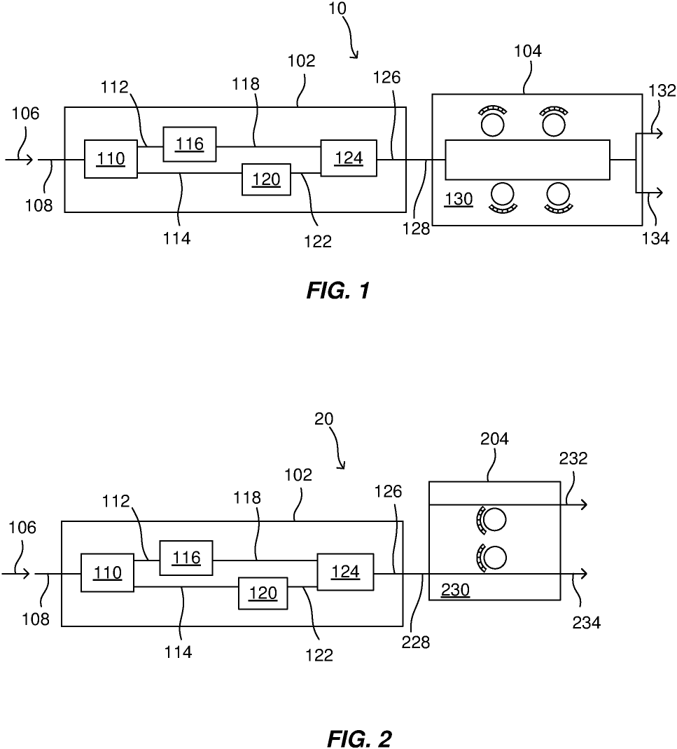

To further describe the present technology, examples are now provided with reference to the figures. FIG. 1 shows a schematic view of a PIC bandpass filter with polarization diversity according to one example of the present disclosure. As shown in FIG. 1, a PIC bandpass filter 10 can comprise a polarization management stage 102 and a filter stage 104. It is noted that the word “stage” is intended to be a structural term that comprises or that refers to one or more components or elements of the PIC bandpass filters as discussed herein. Each of the polarization management stage 102 and the filter stage 104 can be formed as at least part of an on-chip architecture of the photonic integrated circuit. In some examples, each of the polarization management stage 102 and the filter stage 104 can be built into a single integrated chip. In other examples, the polarization management stage 102 and filter stage 104 can be formed on separate chips.

Each of the polarization management stage 102 and the filter stage 104 can be formed as at least part of an on-chip architecture that can comprise any number of suitable materials. For example, such materials can include silicon, silicon nitride, III/V (e.g. Gallium Arsenide, InP), III-Nitride (e.g. Aluminum Nitride, Gallium Nitride), or the like. In some examples, the polarization management stage 102 and the filter stage 104 can benefit from heterogenous integration of different material to provide a more optimal performance. In one example, the polarization management stage 102 can comprise silicon waveguide circuitries, and the filter stage 104 can comprise silicon nitride waveguide circuitries. In this example, ultralow loss and narrow bandwidth filters can be achieved due to the low loss of silicon nitride. When heterogenous integration of materials is utilized between the polarization management stage 102 and the filter stage 104, there can be an adiabatic transition stage from the polarization management stage 102 (e.g. a silicon waveguide layer) at the output of the polarization management stage 102 to an input of the filter stage (e.g. a silicon nitride waveguide layer).

The polarization management stage 102 can be operable to receive a polarization diverse light input 106 and to output an intermediate beam 126 that has a uniform polarization. In one example, the polarization diverse light input 106 can comprise a broadband LED source that is sent to an on-chip polarization stage input 108 of the polarization management stage 102. The polarization diverse light input 106 can comprise light having mixed polarization. For example, the polarization diverse light input 106 can comprise a transverse electric polarization (in-plane polarization) and a transverse magnetic polarization (out-of-plane polarization) that is received at the polarization stage input 108.

In this example, the polarization management stage 102 can comprise a light splitter 110. The light splitter 110 can receive the polarization diverse light input 106 and split the polarization diverse light input 106 into a first beam 112 that has a first polarization and a second beam 114 that has a second polarization. For example, the light splitter 110 can split the polarization diverse light input 106 such that the first beam 112 comprises a transverse magnetic polarization (or an out-of-plane polarization) and the second beam 114 comprises a transverse electric polarization (or an in-plane polarization). The light splitter 110 can be any suitable on-chip light splitter that is incorporated into the architecture of the polarization management stage 102. It is noted that the paths of the various light beams shown in the figures can be any suitable on-chip optical wave guide that creates an optical path on the PIC bandpass filter.

The first beam 112 (the beam having the transverse magnetic polarization or out-of-plane polarization) can proceed from the light splitter 110 to a polarization rotator 116 of the polarization management stage 102. The polarization rotator 116 can rotate the polarization of the first beam 112 that is received at the polarization rotator 116 and output the first beam with a rotated polarization 118. The first beam with the rotated polarization 118 can have a rotated polarization that matches the polarization of the second beam 114 (i.e. a transverse electric polarization or an in-plane polarization). The polarization rotator 118 can be any suitable on-chip polarization rotator that is incorporated into the architecture of the polarization management stage 102.

The polarization management stage 102 can also comprise a phase shifter 120. The phase shifter 120 can be operable to receive the second beam 114 and to shift the phase of the second beam 114 to match the phase of the first beam with the rotated polarization 118. Thus, the phase shifter 120 can output the second beam 114 as a phase shifted beam 122 such that the phase shifted beam 122 has a phase that will not interfere with the first beam with the rotated polarization 118. In other words, the phase shifter 120 can be operable to ensure that the phase shifted beam 112 and the first beam with the rotated polarization 118 can be coherently and constructively combined. The phase shifter 120 can comprise any suitable on-chip phase shifter that is incorporated in the architecture of the polarization management stage 102.

The first beam 112 that has been rotated by the polarization rotator 116 to the first beam with the rotated polarization 118 and the second beam 114 that has been phase shifted by the phase shifter 120 to the phase shifted beam 122 can be combined together by a beam coupler 124 of the polarization management stage 102. The beam coupler 124 can output an intermediate beam 126. The intermediate beam 126 can comprise a uniform polarization. In this example, the intermediate beam 126 can comprise a transverse electric polarization (or an in-plane polarization). The intermediate beam 126 can be output from the polarization management phase 102 to a filter input 128 of the filter stage 104. In this manner, the polarization management stage 102 can facilitate the transfer of energy of both the in-plane and out-of-plane polarization of the polarization diverse light input 106 to the filter stage 104 of the PIC bandpass filter 10.

The filter stage 104 can be operable to receive the intermediate beam 126 from the polarization management stage 102, to filter the intermediate beam 126, and to output a filter output beam. The filter stage 104 can comprise an on-chip filter 130. As mentioned above, typical on-chip filters are sensitive to the input signal polarization due to their strong refractive index contrast. However, in this example, the intermediate beam 126 received at the filter input 128 comprises a uniform polarization (e.g. a transverse electric polarization or in-plane polarization). Thus, the full energy of the polarization diverse light input 106 received at the PIC bandpass filter 10 can be filtered by the filter 130 of the filter stage 104 (absent expected losses that occur in the polarization management stage 102).

The on-chip filter 130 can be any desired suitable filter based on a particular application. In the example shown in FIG. 1, the filter 130 can be a bandpass filter designed for transverse electric polarization and can be based on a ring-assisted Mach-Zehnder interferometer (RAMZI) architecture. The filter 130 can be a fourth order filter comprising two ring resonators that can be tuned to desired frequencies at each arm of a Mach-Zehnder interferometer. Of course, this filter is merely exemplary and it is contemplated that other desired filters can be used. The filter stage 104 can filter the intermediate beam 126 and can output a first filter output 132 and a second filter output 134. The first and second filter outputs 132, 134 can be collected, for example, by a lensed fiber and can be sent to an output device depending on a desired application.

In some examples, the phase shifter 120 can be tuned based on the first filter output 132 and the second filter output 134. To ensure that the phase shifted beam 112 and the first beam with the rotated polarization 118 have an aligned or matching phase such that they can be coherently and constructively combined, at least of the first filter output 132 and the second filter output 134 can be monitors to determine whether an expected amount of energy is output by the PIC bandpass filter 10. If the determined amount of energy is less than an expected output, the phase shifter 120 can be tuned to reduce any interference between the phase shifted beam 112 and the first beam with the rotated polarization 118. In some examples, this can be done manually via an operator measuring at least one of the first filter output 132 and second filter output 134 and tuning the phase shifter 120. In another example, the phase shifter can be tuned autonomously such as via a microcontroller operable to monitor at least one of the first filter output 132 and second filter output 134 and to tune the phase shifter 120 to ensure coherent and constructive combination of the phase shifted beam 112 and the first beam with the rotated polarization 118.

As mentioned above, a PIC bandpass filter with polarization diversity is not limited to a single filter type. FIG. 2 shows a schematic view of PIC bandpass filter with polarization diversity according to one example of the present disclosure. In FIG. 2, a PIC bandpass filter 20 comprises a polarization management stage 102 that is similar to the polarization management stage 102 shown in FIG. 1. In this example, the polarization management stage 102 outputs the intermediate beam 126 to a filter input 228 of a filter stage 204. The filter stage 204 in this example can comprise a filter 230 that can be made of cascaded coupled resonator filters. The filter stage 204 can comprise a first filter output 232 and a second filter output 234. The first and second filter outputs 232, 234 can be collected, for example, by a lensed fiber and can be sent to an output device depending on a desired application. It is noted again that the filter stage 204 can comprise any suitable filter based on a desired application, and that the filters 130, 230 shown in FIGS. 1 and 2 are exemplary and are not intended to be limiting in any way.

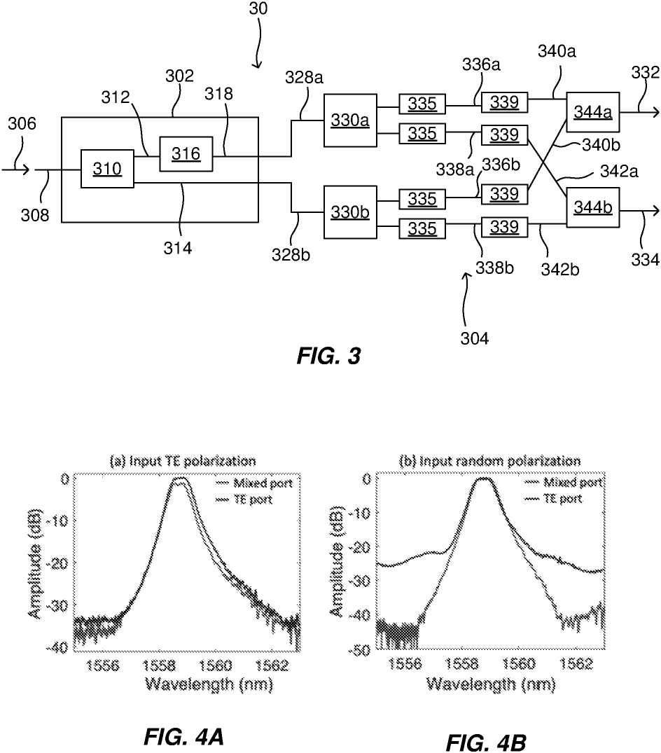

FIG. 3 shows a schematic view of a PIC bandpass filter with polarization diversity according to an example of the present disclosure. In FIG. 3, a PIC bandpass filter 30 is provided. Similar to the PIC bandpass filters 10, 20, the PIC bandpass filter 30 can be configured and operable to transfer energy from in-plane and out-of-plane polarization of a polarization diverse light input 306 to a filter stage 304 of the bandpass filter 30. The PIC bandpass filter 30 can comprise a polarization management stage 302 and a filter stage 304. Each of the polarization management stage 302 and the filter stage 304 can be formed as at least part of an on-chip architecture of the photonic integrated circuit.

The polarization management stage 302 can be configured and operable to receive a polarization diverse light input 306 and to output intermediate beams that have similar polarizations. In one example, the polarization diverse light input 306 can comprise a broadband LED source that is sent to an on-chip polarization stage input 308 of the polarization management stage 302. The polarization diverse light input 306 can comprise light having mixed polarization. For example, the polarization diverse light input 306 can comprise a transverse electric polarization (in-plane polarization) and a transverse magnetic polarization (out-of-plane polarization) that is received at the polarization stage input 308.

In this example, the polarization management stage 302 can comprise a light splitter 310. The light splitter 310 can receive the polarization diverse light input 306 and split the polarization diverse light input 306 into a first beam 312 that has a first polarization and a second beam 314 that has a second polarization. For example, the light splitter 310 can split the polarization diverse light input 306 such that the first beam 312 comprises a transverse magnetic polarization (or an out-of-plane polarization) and the second beam 314 comprises a transverse electric polarization (or an in-plane polarization). The light splitter 310 can be any suitable on-chip light splitter that is incorporated into the architecture of the polarization management stage 302.

The first beam 312 (the beam having the transverse magnetic polarization or out-of-plane polarization) can proceed from the light splitter 310 to a polarization rotator 316 of the polarization management stage 302. The polarization rotator 316 can rotate the polarization of the first beam 312 that is received at the polarization rotator 316 and output the first beam with a rotated polarization 318. The first beam with the rotated polarization 318 can have a rotated polarization that matches the polarization of the second beam 314 (i.e. a transverse electric polarization or an in-plane polarization). The polarization rotator 318 can be any suitable on-chip polarization rotator that is incorporated into the architecture of the polarization management stage 302.

The first beam with the rotated polarization 318 and the second beam 314 can be output from the polarization management stage 302 as first and second intermediate beams that can be received by the filter stage 304. For example, the filter stage 304 can comprise a first filter input 328a at a first filter 330a that receives and filters the first beam with the rotated polarization 318 and a second filter input 328b at a second filter 330b that receives and filters the second beam 314. The first and second filters 330a, 330b can be any suitable on-chip filter based on a given application.

In one example, the first and second filters 330a, 330b can be operable with photodiodes or photodetectors 335. The photodetectors 335 can be integrated into the same chip as the first and second filters, 330a, 330b or the photodetectors 335 can be on a separate chip, or can be an off-chip component. The photodetectors 335 can convert optical outputs from the first and second filters into RF signals or clock signals. In this manner, the first filter 330a and its respective photodetectors 335 can be operable to output a first filtered intermediate output 336a and a first intermediate clock signal 338a. Similarly, the second filter 330b and its respective photodetectors 335 can be operable to output a second filtered intermediate output 336b and a second intermediate clock signal 338b.

In some examples, each of these outputs 336a, 336b and clock signals 338a, 338b can be sent to a bias-tee 339. The bias-tee 339 can be configured and operable to add a desired voltage to each of the outputs 336a, 336b, and clock signals 338a, 338b. The bias-tees 339 can output a first biased intermediate output 340a and a second biased intermediate output 340b to a first power combiner 344a. Similarly, the bias-tees 339 can output a first biased clock output 342a and second biased clock output 342b to a second power combiner 344b. Similar to photodetectors 335, the bias-tees 339 can be integrated into the same chip as the first and second filters 330a, 330b, or can be formed on a separate chip, or can be formed as an off-chip component.

The power combiner 344a can be configured to combine the first and second biased intermediate outputs 340a, 340b (if a bias-tee 339 is not incorporated, then the power combiner 344a can be configured to combine the first and second filtered intermediate outputs 336a, 336b). The power combiner 344b can be configured to combine the first and second biased clock outputs 342a, 342b (if a bias-tee 339 is not incorporated, then the power combiner 344b can be configured to combine the first and second intermediate clock signals 338a, 338b). The first power combiner 344a can output a first filter output 332 and the second power combiner 344b can output a second filter output 334. The first and second filter outputs 332, 334 can be collected, for example, by a lensed fiber and can be sent to an output device depending on a desired application.

In each of the above examples, the PIC bandpass filters 10, 20, 30 can transfer energy from in-plane and out-of-plane polarization of a polarization diverse light input to a filter stage of the bandpass filter 10, 20, 30. This allows the bandpass filters 10, 20, 30 to be polarization insensitive.

FIGS. 4A and 4B show examples of measured spectral responses of a filter structure comparing a PIC bandpass filter with polarization diversity such as those shown in FIGS. 1-3 to a PIC bandpass filter without polarization diversity. FIG. 4A shows a baseline measured spectral response for a PIC bandpass filter with polarization diversity (e.g., see any one of bandpass filters 10, 20, or 30 described above). In FIG. 4A, linearly polarized transverse electric light was input to the PIC bandpass filter at both the polarization stage input (e.g., see any one of polarization stage inputs 108, 308 discussed herein) (mixed port) and at the filter input (e.g., see any one of filter inputs 128, 228, 328a, 328b discussed herein) (TE Port) of the filter stage. As shown in FIG. 4A, similar performance was observed with out-of-band rejection of approximately 35-50 dB. This also verifies that the on-chip polarization management stage does not introduce any significant extra loss and distortion. In FIG. 4B, polarization diverse light input was input to the PIC bandpass filter (e.g., see any one of bandpass filters 10, 20, 30 discussed herein) at both the polarization stage input (e.g., see any one of polarization stage inputs 108, 308 discussed herein) (mixed port) and at the filter input (e.g., see any one of filter inputs 128, 228, 328a, 328b discussed herein) (TE Port). As shown in FIG. 4B, the mixed port shows more than 40 dB out-of-band rejection while the TE port has approximately 25 dB out-of-band rejection. Based on this, it can be shown that the PIC bandpass filter 10, 20, 30 can be demonstrated as polarization insensitive.

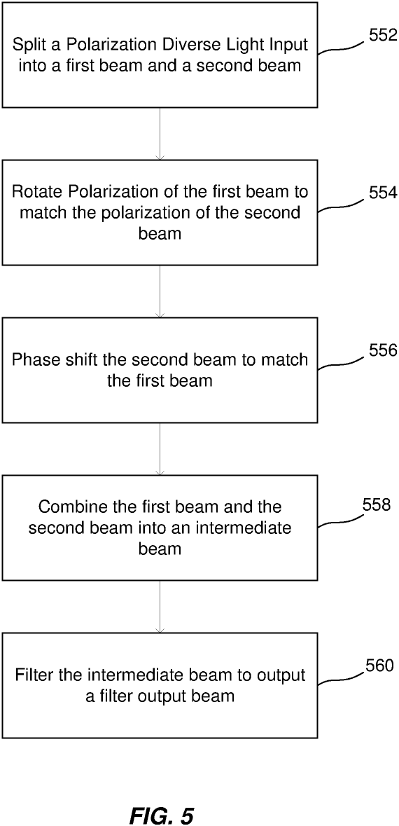

FIG. 5 shows a method of filtering polarization diverse light input on a photonic integrated circuit (“PIC”) bandpass filter according to one example of the present disclosure. As shown in FIG. 5, a polarization diverse light input is split into a first beam and a second beam in step 552. As explained above with reference to the PIC bandpass filters 10, 20, 30 (see FIGS. 1-3), a polarization diverse light input 106, 306 can be input to polarization stage input 108, 308 and can be split by a light splitter 110, 310 into a first beam 112, 312 with a first polarization (e.g. a transverse electric or in-plane polarization) and a second beam 114, 314.

In step 554, the polarization of the first beam can be rotated to match the polarization of the second beam. As explained above, a polarization rotator 116, 316 can rotate the polarization of the first beam 112, 312 to output a first beam with a rotated polarization 118, 318 that matches the polarization of the second beam 114. With the first beam and the second beam having the same polarization, the energy of both the first beam and the second beam can be transferred to a filter stage (e.g. filter stages 104, 204, 304 discussed above).

In step 556, the second beam can be phase shifted to match a phase of the first beam. For example, the second beam 114 can be received by the phase shifter 120 to shift the phase of the second beam 114 such that the phase of the second beam 114 can match the phase of the first beam with the rotated polarization 118 prior to combing the beam. The phase shifter 120 can output the second beam 114 as a phase shifted beam 122 such that the phase shifted beam 122 has a phase that will not interfere with the first beam with the rotated polarization 118.

In step 558, the first beam and the second beam can be combined into an intermediate beam. For example, the first beam having the rotated polarization 118 and the phase shifted beam 122 can be combined by a beam coupler 124 of the polarization management stage 102. The beam coupler 124 can output an intermediate beam 126. The intermediate beam 126 can comprise a uniform polarization. In this example, the intermediate beam 126 can comprise a transverse electric polarization (or an in-plane polarization).

In step 560, the intermediate beam (which is a combination of the first beam and the second beam) can be filtered to output a filter output beam. For example, a filter stage 104, 204 can comprise an on-chip filter 130, 230 that can be configured and operable to filter the intermediate beam to output a filter output beam such as a first filter output 132, 232 and a second filter output 134, 234. As mentioned above, typical on-chip filters are sensitive to the input signal polarization due to their strong refractive index contrast. However, in this example, the intermediate beam can comprise a uniform polarization (e.g. a transverse electric polarization or in-plane polarization). Thus, the full energy of the polarization diverse light input received at the PIC bandpass filter can be filtered (absent expected losses that can occur in steps 552, 554, 556, and 558).

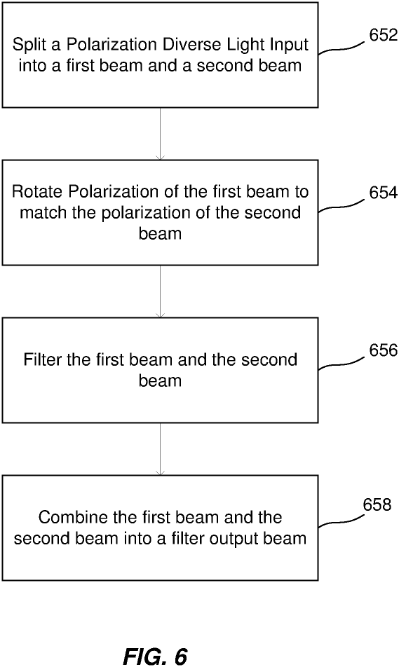

FIG. 6 shows a method of filtering polarization diverse light input on a photonic integrated circuit (“PIC”) bandpass filter according to one example of the present disclosure. As shown in FIG. 6, a polarization diverse light input is split into a first beam and a second beam in step 652. As explained above with reference to the PIC bandpass filters 10, 20, 30 (see FIGS. 1-3), a polarization diverse light input 106, 306 can be input to polarization stage input 108, 308 and can be split by a light splitter 110, 310 into a first beam 112, 312 with a first polarization (e.g. a transverse electric or in-plane polarization) and a second beam 114, 314.

In step 654, the polarization of the first beam can be rotated to match the polarization of the second beam. As explained above, a polarization rotator 116, 316 can rotate the polarization of the first beam 112, 312 to output a first beam with a rotated polarization 118, 318 that matches the polarization of the second beam 114. With the first beam and the second beam having the same polarization, the energy of both the first beam and the second beam can be transferred to a filter stage (e.g. filter stages 104, 204, 304 discussed above).

In step 656, the first beam and the second beam can be filtered by an on-chip filter. For example, as explained above with reference to FIG. 3, the first beam with the rotated polarization 318 and the second beam 314 can be output from the polarization management stage 302 as first and second intermediate beams that can be received by the filter stage 304. For example, the filter stage 304 can comprise a first filter input 328a at a first filter 330a that receives and filters the first beam with the rotated polarization 318 and a second filter input 328b at a second filter 330b that receives and filters the second beam 314. The first and second filters 330a, 330b can be any suitable on-chip filter based on a given application.

In step 658, the first beam and the second beam can be combined into a filter output beam. For example, the first filter 330a can be operable to output a first filtered intermediate output 336a, and the second filter 330b can be operable to output a second filtered intermediate output 336b. The first and second filtered intermediate outputs 336a, 336b can be sent to a bias-tee 339. The bias-tee 339 can be configured and operable to add a desired voltage to each of the outputs 336a, 336b. The bias-tees 339 can output a first biased intermediate output 340a and a second biased intermediate output 340b to a first power combiner 344a. The power combiner 344a can combine the first biased intermediate output 340a and the second biased intermediate output 340b into the first filter output 332. Thus, the full energy of the polarization diverse light input received at the PIC bandpass filter can be filtered (absent expected losses that can occur in steps 652, 654, and 658).

Thus, as set forth herein, a PIC bandpass filter is provided that is insensitive to polarization. Further, a method for filtering polarization diverse light input on a PIC bandpass filter is provided. As compared with typical PIC filters are polarization sensitive and can require a uniform polarization light input, the above filter and method can be compatible with a polarization diverse light input (i.e. light input without uniform polarization or having a random polarization). Thus, the full energy of a polarization diverse light input can be transferred to the filter (of course, absent expected losses). In one example, this can facilitate the use of standard optical fibers which, in practice, carry random polarization of light. Thus, standard optical fibers can be used to transmit light over distances which can decrease costs due to fabrication and materials in many applications.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A photonic integrated circuit (“PIC”) bandpass filter with polarization diversity comprising:
a polarization management stage operable to receive a polarization diverse light input and to output an intermediate beam having a uniform polarization; and
a filter stage operable to receive the intermediate beam from the polarization management stage, to filter the intermediate beam, and to output a filter output beam,
wherein energy from an in-plane polarization and an out-of-plane polarization of the polarization diverse light input is transferred to the filter stage.

2. The PIC bandpass filter of claim 1, wherein the polarization management stage comprises a light splitter operable to split the polarization diverse light input into a first beam having a first polarization and a second beam having a second polarization different than the first polarization.

3. The PIC bandpass filter of claim 2, wherein the polarization management stage comprises a polarization rotator operable to rotate the first polarization of the first beam such that the first beam comprises a rotated polarization that matches the second polarization.

4. The PIC bandpass filter of claim 3, wherein the polarization management stage comprises a beam coupler coupling the first beam having the rotated polarization and the second beam having the second polarization into an intermediate beam.

5. The PIC bandpass filter of claim 4, wherein the polarization management stage comprises a phase shifter operable to shift a phase of the second beam to match a phase of the first beam prior to the first and second beams being received by the beam coupler for coherent and constructive combining of the first beam and the second beam.

6. The PIC bandpass filter of claim 1, wherein the intermediate beam comprises a first intermediate beam and a second intermediate beam, and wherein the filter stage comprises a first filter that receives the first intermediate beam and a second filter that receives the second intermediate beam.

7. The PIC bandpass filter of claim 6, wherein the first filter outputs a first filtered intermediate output and the second filter outputs a second filtered intermediate output.

8. The PIC bandpass filter of claim 7, wherein the filter stage further comprises a power combiner operable to receive and combine the first filtered intermediate output and the second filtered intermediate output to output the filter output beam.

9. The PIC bandpass filter of claim 8, wherein the filter stage further comprises photodetectors associated with the first filter and the second filter, respectively, and wherein the photodetectors are operable to convert an optical signal to an RF signal to output the first filtered intermediate output and the second filtered intermediate output from the first and second filters, respectively.

10. The PIC bandpass filter of claim 8, wherein the filter stage further comprises a bias tee operable to receive the first filtered intermediate output and the second filtered intermediate output and to output a first biased intermediate output and a second biased intermediate output to the power combiner.

11. A photonic integrated circuit (“PIC”) bandpass filter with polarization diversity comprising:
a polarization management stage comprising:
a light splitter operable to split a polarization diverse light input into a first beam having a first polarization and a second beam having a second polarization different than the first polarization, and
a polarization rotator operable to rotate the first polarization of the first beam such that the first beam comprises a rotated polarization that matches the second polarization, and
a filter stage operable to receive and filter the first beam and the second beam received from the polarization management stage and to output a filter output beam,
wherein energy from an in-plane polarization and an out-of-plane polarization of the polarization diverse light input is transferred to the filter stage.

12. The PIC bandpass filter of claim 11, wherein the polarization management stage comprises a beam coupler coupling the first beam having the rotated polarization and the second beam having the second polarization into an intermediate beam, wherein the filter stage is operable to receive and filter the intermediate beam to output the filter output beam.

13. The PIC bandpass filter of claim 12, wherein the polarization management stage comprises a phase shifter operable to shift a phase of the second beam to match a phase of the first beam prior to the first and second beams being received by the beam coupler for coherent and constructive combining of the first beam and the second beam.

14. The PIC bandpass filter of claim 11, wherein the filter stage comprises a first filter that receives the first beam and a second filter that receives the second beam.

15. The PIC bandpass filter of claim 14, wherein the first filter outputs a first filtered intermediate output and the second filter outputs a second filtered intermediate output.

16. The PIC bandpass filter of claim 15, wherein the filter stage further comprises a power combiner operable to receive and combine the first filtered intermediate output and the second filtered intermediate output to output the filter output beam.

17. The PIC bandpass filter of claim 16 wherein the filter stage further comprises photodetectors associated with the first filter and the second filter, respectively, and wherein the photodetectors are operable to convert an optical signal to an RF signal to output the first filtered intermediate output and the second filtered intermediate output from the first and second filters, respectively.

18. The PIC bandpass filter of claim 16, wherein the filter stage further comprises a bias tee operable to receive the first filtered intermediate output and the second filtered intermediate output and to output a first biased intermediate output and a second biased intermediate output to the power combiner.

19. A method for filtering polarization diverse light input on a photonic integrated circuit (“PIC”) bandpass filter, the method comprising:
splitting a polarization diverse light input into a first beam having a first polarization and a second beam having a second polarization than the first polarization;
rotating the first polarization of the first beam such that the first beam comprises a rotated polarization that matches the second polarization of the second beam;
filtering the first beam comprising the rotated polarization and the second beam comprising the second polarization; and
outputting a filter output beam.

20. The method of claim 19, further comprising combining the first beam and the second beam into an intermediate beam prior to the filtering.

21. The method of claim 20, further comprising phase shifting the second beam prior to the combining such that a phase of the second beam matches a phase of the first beam.

22. The method of claim 19, wherein the first beam is filtered by a first filter to output a first filtered intermediate output, the second team is filtered by a second filter to output a second filtered intermediate output, and the first filtered intermediate output is combined with the second filtered intermediate output to output the filter output beam.
